(19) United States
(12) Patent Application Publication
(10) Pub. No.: US 2015/0240322 A1
(43) Pub. Date: Aug. 27, 2015

(54) SLAG REMOVAL DEVICE AND SLAG REMOVAL METHOD

(71) Applicant: MITSUBISHI HEAVY INDUSTRIES, LTD., Tokyo (JP)

(72) Inventors: Masakazu Sakaguchi, Tokyo (JP); Tsutomu Hamada, Tokyo (JP); Takeshi Okada, Tokyo (JP); Setsuo Omoto, Tokyo (JP); Keiichi Nakagawa, Tokyo (JP)

(73) Assignee: MITSUBISHI HEAVY INDUSTRIES, LTD., Tokyo (JP)

(21) Appl. No.: 14/428,907

(22) PCT Filed: Sep. 10, 2013
(86) PCT No.: PCT/JP2013/074414

§ 371 Date: Mar. 17, 2015

(30) Foreign Application Priority Data
Sep. 20, 2012 (JP) 2012-207275

(51) Int. Cl. C21B 7/00; F27D 3/15; F27D 25/00; C21B 5/00

(52) U.S. Cl. CPC C21B 7/00; C21B 5/003; C21B 5/001; F27D 3/1545; F27D 25/00

(57) ABSTRACT

Provided is a slag removal device for a blast furnace, capable of readily and reliably achieving slag removal using a simple device configuration, even when pulverized coal is used that has not had the softening temperature thereof adjusted, and capable of reducing as much as possible the risk of pipe damage, etc. The slag removal device for a blow pipe is provided in a blow pipe that injects auxiliary fuel pulverized coal together with hot air from a tuyere for a blast furnace main body that produces pig iron from iron ore. A jet nozzle that injects solids having a higher fusion point than the temperature in the vicinity of the tuyere and having a particle diameter greater than that of the pulverized coal, into pulverized coal that flows inside the blow pipe and into the hot air, is provided in the slag removal device.

### TECHNICAL FIELD

The present invention relates to a slag removal device and a slag removal method for a blow pipe for use with a blast furnace, and in particular, to a slag removal device and a slag removal method that can be advantageously used on a blow pipe for injecting pulverized coal obtained by crushing low-grade coal into a furnace as an auxiliary fuel along with hot air.

### BACKGROUND ART

A blast furnace is used to produce pig iron from iron ore by introducing feedstocks such as iron ore, limestone, coal, and the like into the interior of a blast furnace main body from the apex thereof, and injecting hot air and pulverized coal (PCI coal) as an auxiliary fuel through a tuyere located toward the bottom on a side of the furnace.

In a blast furnace of this sort, if low-grade coal generally having a low ash melting point of 1,100 to 1,300° C., such as sub-bituminous coal or lignite, is used as the pulverized coal during the operation of injecting pulverized coal, the oxygen contained in the roughly 1,200° C. hot air used to inject the pulverized coal into the furnace engages in a combustion reaction with part of the pulverized coal. The combustion heat generated thereby causes low-melting point coal (“slag”) to melt within the injection lance or tuyere.

The melted slag is rapidly cooled through contact with the tuyere, which is constantly cooled in order to protect it from the temperature of the blast furnace. As a result, solid slag adheres to the tuyere, leading to the problem of blockage in the blow pipe flow path.

In order to solve such a problem, for example, in a case where the slag softening temperature in the pulverized coal is low, as in the technique of the related art disclosed in Patent Document 1 described below, a softening temperature adjusting process is performed so as to reach a melting point which is the temperature inside the furnace or higher, and the slag is prevented from adhering to the tuyere.

In addition, Patent Document 2 described below discloses removing slag by injecting hard balls into a tuyere from a furnace-exterior side end of the tuyere.

Furthermore, in order to remove deposits which accumulate in gaps formed at end sections of two lances, Patent Document 3 described below discloses vibrating the lances by injecting solid chips with a particle diameter of 1 to 2 mm.

### CITATION LISTS

### Patent Literatures

Patent Document 1: Japanese Unexamined Patent Application No. H05-156330A

Patent Document 2: Japanese Unexamined Patent Application No. H06-192714A

Patent Document 3: Japanese Unexamined Patent Application Publication No. 2006-63376A

### SUMMARY OF THE INVENTION

### Problems to be Solved by the Invention

However, the following problems have been pointed out in the related art techniques described above.

A problem with the related art technique disclosed in Patent Document 1 is that completely (uniformly) mixing pulverized coal and solid additives (a slag making agent) is difficult and, as a result, it is not possible to prevent slag forming in a portion where the mixing ratio of the additives is less than a predetermined value. In addition, in a case of using additives, there is also a problem in that extra costs are incurred since a new source of calcium oxide (CaO) such as limestone or serpentine is necessary.

Next, a problem with the related art technique disclosed in Patent Document 2 is that all of the hard balls do not always collide with the slag. Thus, if there are any hard balls that do not collide with the slag, there is a concern that these balls will directly collide with the inner surface of the blow pipe, creating the risk of problematic damage to the pipe or the like from the collision of the balls. In Patent Document 2, the slag broken using the hard balls is formed on air injection tuyeres and insulation rings.

The related art technique disclosed in Patent Document 3 is for vibrating lances and application thereof to a blow pipe or a tuyere is difficult.

In view of these circumstances, there is a demand for a slag removal device for a blow pipe for use with blast furnace facilities that allows for easy and reliable slag removal using as simple a device arrangement as possible without adjusting a softening temperature. In addition, there is a demand for a slag removal device for a blow pipe for use with blast furnace facilities that reduces the risk of pipe damage and the like as much as possible and allows for easy and reliable slag removal using as simple a device arrangement as possible.

The present invention has been made to solve the problems described above and an object of the present invention is to provide a slag removal device and a slag removal method for a blast furnace which are able to achieve easy and reliable slag removal using a simple device configuration even when using pulverized coal that has not had the softening temperature thereof adjusted and which are capable of reducing as much as possible the risk of pipe damage, and the like.

### Means for Resolving the Problems

In order to solve the problem described above, the present invention employs the following means.

A slag removal device according to a first aspect of the present invention is a slag removal device for a blow pipe which is provided in a blow pipe that injects pulverized coal as an auxiliary fuel along with hot air from a tuyere of a blast furnace main body that produces pig iron from iron ore, with slag of the pulverized coal including a component that melts as a result of the hot air and/or combustion heat of the pulverized coal. The slag removal device is provided with a jet nozzle that injects solids having a higher melting point than the temperature in the vicinity of the tuyere and having a particle diameter greater than that of the pulverized coal, into the pulverized coal that flows inside the blow pipe and into the hot air, the jet nozzle being provided with a solids supply system that supplies the solids and has provided therein an open/close control valve.

According to the slag removal device according to the first aspect of the present invention, there is provided a jet nozzle that injects solids having a higher melting point than the temperature in the vicinity of the tuyere and having a particle diameter greater than that of the pulverized coal, into the pulverized coal that flows inside the blow pipe and into the hot air. Also, the jet nozzle is provided with a solids supply system that supplies the solids and has provided therein an open/close control valve. Thereby, the solids that are blown from the jet nozzle into the interior of the blow pipe proceed without melting with the flow of hot air as a propulsive force, and it is possible to remove slag by applying a mechanical impact to slag adhered in the vicinity of the tuyere. In such a case, it is possible to use the flow of the hot air as the propulsive force of the solids inside the blow pipe.

Examples of suitable solids include granular coal, slag, lime grains, pellet grains, sintered ore, iron powder, and the like, and one type or a mixture of a plurality of types may be used from among these.

It is preferable that the invention described above be provided with a swirling flow forming section that generates a swirling flow in a flow of the hot air at a position on an upstream side from an injection lance that injects the pulverized coal in an interior of the blow pipe.

Due to this, the blown solids are concentrated near and collide with a pipe inner surface or a tuyere inner surface where slag is adhered as a result of centrifugal force due to the swirling flow formed inside the blow pipe.

It is preferable that the invention described above be provided with a jet nozzle that ejects a liquid toward a slag adhesion area inside the blow pipe, the jet nozzle being provided with a liquid supply system that supplies the liquid and has provided therein an open/close control valve.

Due to this, it is possible to carry out the slag removal by quenching the adhered solid slag by liquid ejection and destroying the solid slag by thermal compression before performing the slag removal using the solids.

The jet nozzle for the solids and the jet nozzle for the liquid described above may each be provided separately, or may be an integrated nozzle where it is possible to select the ejection material by changing the flow channel with an opening and closing operation of the open/close control valve.

It is desirable that the invention described above be provided with a slag detecting means that detects a slag adhesion status according to a pressure differential between hot air pressure on an upstream side of the jet nozzle and hot air pressure in a vicinity of an outlet of the blow pipe.

The adhesion of the slag reduces the cross-sectional area of the flow path and, as a result, it is possible for the slag detecting means to detect an increase in the pressure differential due to an increase in the pressure loss.

In the invention described above, it is preferable that the liquid and/or the solids be ejected by opening the open/close control valve upon the slag adhesion status detected by the slag detecting means being determined to be a slag removal threshold value or more, and that the ejecting of the liquid and/or the solids be stopped by closing the open/close control valve upon the slag adhesion level detected by the slag detecting means being determined to be less than a slag removal stop threshold value.

Due to this, it is possible to eject liquid from the liquid jet nozzle or solids from the jet nozzle only when necessitated by high slag adhesion levels.

It is preferable that the invention described above be provided with an alarm output threshold value set to a value at which the slag adhesion status is greater than the slag removal threshold value.

Due to this, it is possible to detect that the slag removal is not being performed by the liquid jet nozzle or jet nozzle as planned.

A slag removal method according to a second aspect of the present invention is a slag removal method for a blow pipe which is applied in a blow pipe that injects pulverized coal as an auxiliary fuel along with hot air from a tuyere of a blast furnace main body that produces pig iron from iron ore, with slag of the pulverized coal including a component that melts as a result of the hot air and/or combustion heat of the pulverized coal. The blow pipe is provided with a jet nozzle that injects solids having a higher melting point than the temperature in the vicinity of the tuyere and having a particle diameter greater than that of the pulverized coal, into the pulverized coal that flows inside the blow pipe and into the hot air, and a jet nozzle that ejects a liquid toward a slag adhesion area inside the blow pipe. The method includes steps of removing slag in a first stage where slag removal is initially carried out by ejecting only the liquid from the jet nozzle, and removing slag in a second stage where slag removal is carried out by ejecting only the solids from the jet nozzle upon it not being possible to achieve a predetermined slag removal in the removing slag in a first stage.

According to the slag removal method according to the second aspect of the present invention, there is provided a jet nozzle that injects solids having a higher melting point than the temperature in the vicinity of the tuyere and having a particle diameter greater than that of the pulverized coal, into the pulverized coal that flows inside the blow pipe and into the hot air, and a jet nozzle that ejects a liquid toward a slag adhesion area inside the blow pipe. Also, the method includes steps of removing slag in a first stage where slag removal is initially carried out by ejecting only the liquid from the jet nozzle, and removing slag in a second stage where slag removal is carried out by ejecting only the solids from the jet nozzle upon it not being possible to achieve a predetermined slag removal in the removing slag in a first stage. Thereby, the removing slag in a first stage using liquid ejection with little risk of wear or damage to the pipe in comparison with the collision of the solids is carried out with priority, and more reliable slag removal is possible by carrying out the removing slag in a second stage by ejecting only the solids only in a case where it was not possible to carry out the slag removal with the liquid ejection.

It is desirable that the invention described above be provided with a step of removing slag in a third stage where slag removal is carried out by ejecting the solids and the liquid together upon it not being possible to achieve a predetermined slag removal in the removing slag in a second stage.

Due to this, the reliability of the slag removal is further improved. Examples of suitable liquids in such a case include combustible liquids such as heavy oil.

### EFFECT OF THE INVENTION

According to the slag removal device and slag removal method of the present invention described above, since the slag is destroyed and removed by the ejection of liquid and the ejection of solids, it is possible to achieve easy and reliable slag removal using a simple device configuration even in a case of using pulverized coal that has not had the softening temperature thereof adjusted and it is possible to reduce the risk of wear, damage, or the like to the pipe by prioritizing the liquid ejection.

As a result, even low-grade coals having low ash melting points of 1,100° C. to 1,300° C., such as sub-bituminous coal or lignite, can be used as the pulverized coal constituting the auxiliary fuel through modifications in which these are used as feedstock coal. That is, oxygen included in the approximately 1,200° C. hot air used to inject the auxiliary fuel engages in a combustion reaction with the pulverized coal, and low-melting point slag melted by the combustion heat produced by this combustion reaction comes into contact with and is rapidly cooled by the cold tuyere; thus, even if the slag solidified and adheres to the tuyere, the adhering slag can easily be broken and removed by spraying the same with fluid or solids, preventing blow pipe flow path blockages.

### BRIEF DESCRIPTION OF THE DRAWINGS

FIG. 1 is a schematic illustration of an embodiment of a slag removal device and a slag removal method according to the present invention.

FIG. 2 is a schematic illustration of a modified example of a swirling flow forming section for the slag removal device and the slag removal method depicted in FIG. 1.

FIG. 3 is a main part enlarged view of a configuration example of a slag detecting means for the slag removal device and the slag removal method depicted in FIG. 1.

FIG. 4 is an illustration of an example arrangement of a blast furnace to which the slag removal device and the slag removal method illustrated in FIG. 1 are applied.

### DETAILED DESCRIPTION OF THE INVENTION

Description will be given below of an embodiment of the slag removal device and slag removal method according to the present invention with reference to the drawings.

The slag removal device and slag removal method of the present embodiment are used with a blast furnace in which pulverized low-grade coal constituting the feedstock coal is injected throughout a tuyere into a blast furnace along with hot air.

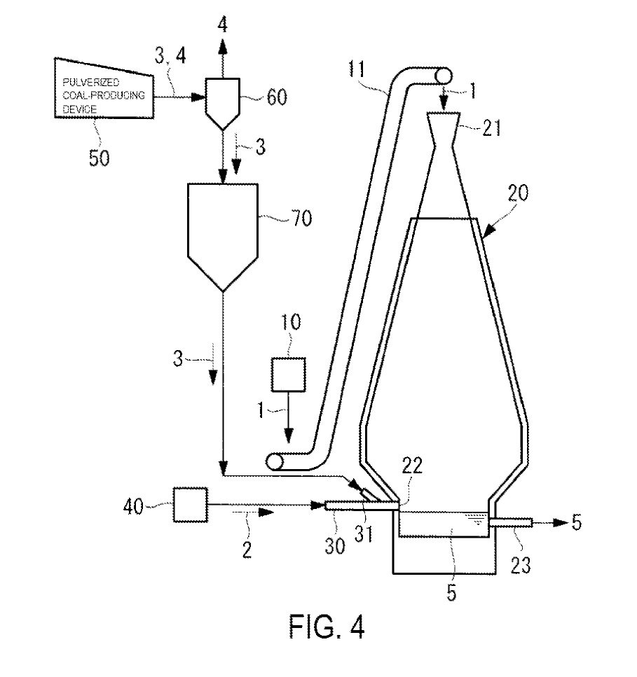

For example, in a blast furnace such as that illustrated in FIG. 4, feedstock 1 constituted by iron ore, limestone, and coal or the like is fed from a metered feedstock feeder 10 via a transport conveyor 11 into a furnace apex hopper 21 provided at the apex of a blast furnace main body 20. A plurality of tuyeres 22 is provided in a lower side wall of the blast furnace main body 20 at a roughly uniform pitch in the circumferential direction. Each of the tuyeres 22 is linked to a downstream end of a blow pipe 30 for feeding hot air 2 into the interior of the blast furnace main body 20. The upstream end of each of the blow pipes 30 is connected to a hot air feeder 40 constituting the source of the hot air 2 supplied to the interior of the blast furnace main body 20.

A pulverized coal producing device 50 that performs a pretreatment (modification) such as evaporating moisture in the coal out of the feedstock coal (sub-bituminous coal, lignite, or other low-grade coal), followed by pulverizing the low-grade coal to produce pulverized coal, is provided near the blast furnace main body 20.

Modified pulverized coal (modified coal) 3 produced by the pulverized coal producing device 50 is conveyed by a carrier gas 4, such as nitrogen gas, to a cyclone separator 60. The pulverized coal 3 conveyed by the gas is separated from the carrier gas 4 by the cyclone separator 60, after which the coal falls into and is stored in a storage tank 70. This modified pulverized coal 3 is used as blast furnace injection coal (PCI coal) for the blast furnace main body 20.

The pulverized coal 3 within the storage tank 70 is fed into an injection lance (hereafter, “lance”) 31 of the blow pipe 30 described above. The pulverized coal 3 combusts upon being fed into the hot air flowing through the blow pipe 30, producing a flame at the end of the blow pipe 30 and forming a raceway. This causes the coal or the like contained in the feedstock 1 being introduced into the blast furnace main body 20 to combust. As a result, the iron ore contained in the feedstock 1 is reduced, becomes pig iron (molten iron) 5, and is removed through a pig iron outlet 23.

Preferred properties of the pulverized coal 3 fed from the lance 31 into the blow pipe 30 as blast furnace injection coal, that is, of the modified pulverized coal (auxiliary fuel) formed by modifying and pulverizing low-grade coal, are an oxygen atom content (dry basis) of 10 to 18 weight %, and an average pore size of 10 to 50 nanometers (nm). A more preferable average pore size for the modified pulverized coal is 20 to 50 nanometers (nm).

In pulverized coal 3 having such properties, there is a large release of and reduction in tar-forming groups of oxygen-containing functional groups (carboxyl groups, aldehyde groups, ester groups, hydroxyl groups, etc.) but breakdown (reduction) of the main skeleton (the combustible component primarily formed from carbon, hydrogen, and oxygen) is greatly suppressed. Thus, when the coal is injected through the tuyeres 22 into the blast furnace main body 20 along with the hot air 2, the high oxygen atom content of the main skeleton and the large diameter of the pores not only facilitates dispersion of the oxygen in the hot air 2 into the coal, but also greatly impedes the generation of tar, allowing for complete combustion with almost no uncombusted carbon (soot) being produced.

In order to produce (modify) this pulverized coal 3, a drying step of heating (at 110 to 200° C. for 0.5 to 1 hours) and drying the sub-bituminous coal, lignite, or other low-grade coal (dry-basis oxygen atom content: greater than 18 weight %; average pore size: 3 to 4 nm) constituting the feedstock coal in a low-oxygen atmosphere having an oxygen concentration of 5 vol % or less is performed in the pulverized coal producing device 50.

After moisture is removed in the drying step described above, a dry distillation step in which the feedstock coal is reheated (at 460 to 590° C., preferably 500 to 550° C., for 0.5 to 1 hours) in a low-oxygen ambient atmosphere (oxygen concentration: 2 vol % or less) is performed. Dry distilling the feedstock coal in this dry distillation step removes generated water, carbon dioxide, and tar in the form of dry distillation gas or dry distillation oil.

The feedstock coal then proceeds to a cooling step in which the coal is cooled (to 50° C. or less) in a low-oxygen atmosphere having an oxygen concentration of 2 vol % or less, then pulverized (particle diameter: 77 μm or less (80% pass)) in a pulverization step.

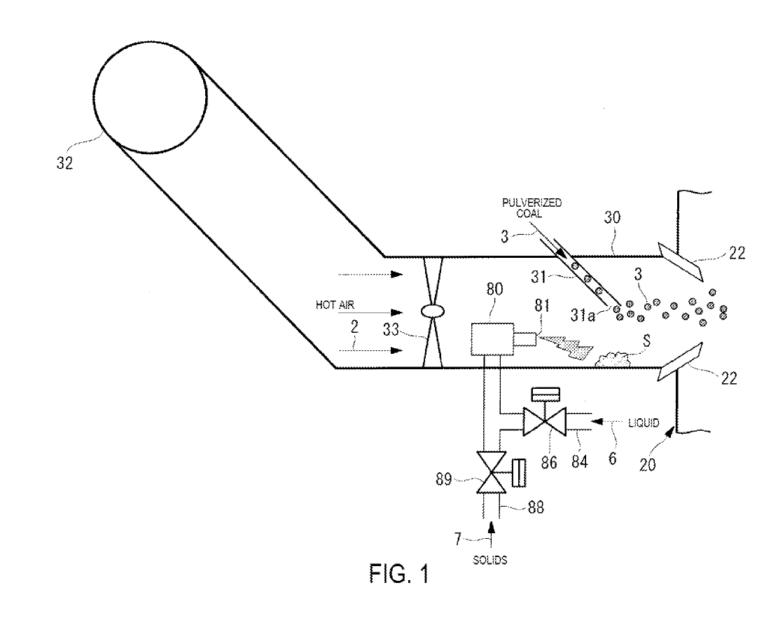

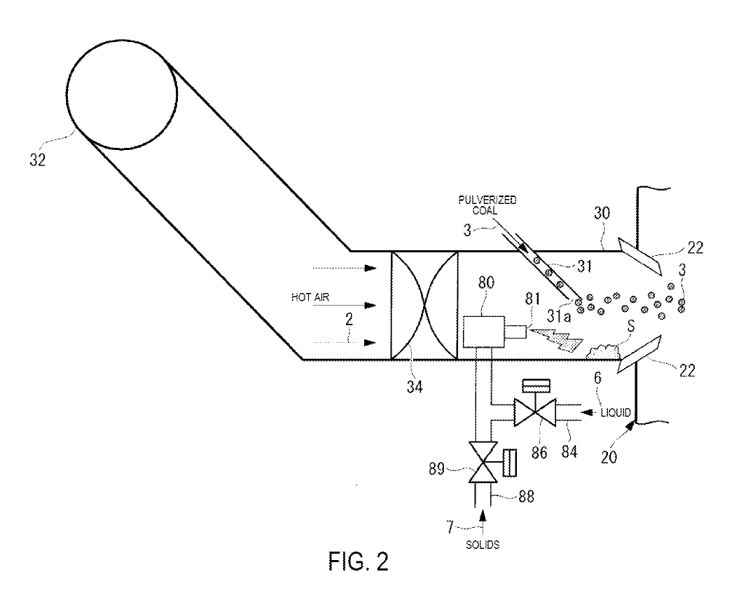

The embodiment, for example, as illustrated in FIG. 1 and FIG. 2, is provided with a jet nozzle 80 for injecting liquid 6 or solids 7 with respect to the interior of the blow pipe 30 in order to remove slag S adhering to the surface of the inner wall of the blow pipe 30, the tuyere 22, and the inner wall in the vicinity thereof constituting slag adhesion areas. One or a plurality of the jet nozzles 80 is appropriately provided in the circumferential direction, for example, along the inner circumferential surface of the blow pipe 30.

In such a case, examples of preferred liquids 6 that are ejected from the jet nozzle 80 include combustible liquids such as water or heavy oil. In addition, examples of preferred solids 7 that are ejected from the jet nozzle 80 include granular coal, slag, lime grains, pellet grains, sintered ore, iron powder, and the like, and one type or a mixture of a plurality of types may be used from among these.

The liquid 6 ejected from the jet nozzle 80 rapidly cools the slag adhering to the blow pipe 30 or in the vicinity of the tuyere 22 by effectively utilizing the latent heat of vaporization the liquid. Since the slag S rapidly cooled as a result of the ejection of the liquid 6 is broken by thermal contraction, it is possible to easily remove the slag S.

In contrast, since the solids 7 which are ejected from the jet nozzle 80 proceed without melting the inside of the blow pipe 30 with the flow of the hot air 2 as a propulsive force, the solids 7 collide with the slag S adhering in the vicinity of the tuyere 22. Accordingly, it is possible for the solids 7 to apply a mechanical impact to the slag S by colliding therewith. As a result, it is possible to easily remove the slag S which undergoes the collision with the solids 7 since the slag S is destroyed by the impact at the time of the collision.

In order to keep the opening of the outlet on a nozzle end 81 from which the fluid 6 or the solids 7 are ejected from being clogged with pulverized coal 3, slag S, or the like, the jet nozzle 80 is preferably disposed at a position substantially aligned, with respect to the axial direction of the blow pipe 30, with an end section 31a of the lance 31 from which the pulverized coal 3 is fed, or slightly to the upstream side thereof. In such a case, the nozzle end 81 of the jet nozzle 80 preferably has a nozzle shape, in particular, for ejecting the fluid in a linear shape in the direction of the tuyere 22, and an arrangement in which the ejection direction can be altered may be adopted, as necessary. If an arrangement in which the ejection direction of the nozzle end 81 can be altered is adopted, the supply pressure of the liquid or a solids carrier gas can be used to swing or rotate the nozzle.

The position with respect to the radial direction at which the jet nozzle 80 is disposed is preferably close to the side wall of the blow pipe 30 so as not to resist the flow path of the hot air 2 and so that the nozzle is capable of directly spraying at slag S adhering to the side wall of the blow pipe 30.

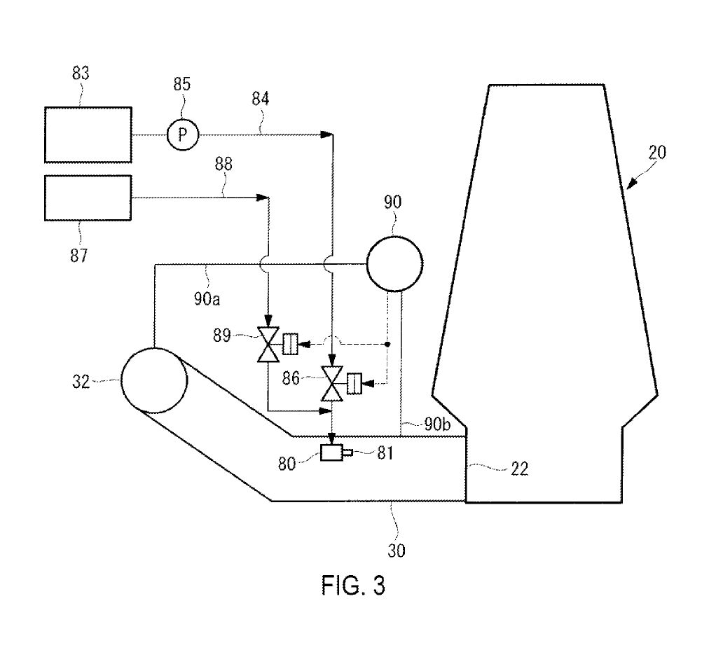

For example, as illustrated in FIG. 3, the jet nozzle 80 is connected to a liquid supply source 83 via a liquid supply pipe 84.

The liquid supply pipe 84 comprises, as primary elements, a delivery pump 85 for pumping the liquid in the liquid supply source 83 to the jet nozzle 80, and an open/close control valve 86 for controlling the liquid supply (on and off) to the jet nozzle 80 by switching between open and closed states.

Furthermore, the jet nozzle 80 is connected to a solids supply source 87 via a solids supply pipe 88.

The solids supply source 87 is provided with a solids carrier gas supply source which is not illustrated in the drawing, for example, such as nitrogen gas or the like, for the solids. The solids supply pipe 88 comprises, as primary elements, an open/close control valve 89 for controlling the solids supply (on and off) to the jet nozzle 80 by switching between open and closed states.

The open/close control valves 86 and 89 are opened and closed according to the value of a pressure differential ΔP measured by a differential pressure gauge 90. Two pressure intake pipes 90a, 90b are connected to the differential pressure gauge 90 so as to measure the pressure differential ΔP between, for example, a main hot air pipe 32 and a downstream position of the blow pipe near the tuyere 22 of the blow pipe 30.

In this manner, the jet nozzle 80 is provided with a liquid supply system that supplies liquid 6 to be ejected and is provided with the open/close control valve 86, a solids supply system that supplies the solids 7 to be ejected and is provided with the open/close control valve 89, and the differential pressure gauge (the slag detecting means) 90 which detects the state of the slag in the slag adhesion area. Accordingly, it is possible for the jet nozzle 80 illustrated in the drawings to select either one of the liquid 6 or the solids 7 from one nozzle end 81 or to eject both of the liquid 6 and the solids 7 at the same time according to the open and closed states of the open/close control valves 86 and 89.

In the following description, as illustrated in the drawings, description will be given of a configuration in which the liquid supply system and the solids supply system are connected to one jet nozzle 80; however, the present invention is not limited to this configuration. Specifically, the liquid supply system and the solids supply system may be configured to be provided with a liquid jet nozzle or a solids jet nozzle which are independent of each other.

The slag adhesion level is determined from the pressure differential between the hot air pressure on the upstream side of the jet nozzle 80 and the hot air pressure in the vicinity of the outlet of the blow pipe 30.

Specifically, when there is slag S adhering to the inner wall of the blow pipe 30 or near the tuyeres 22, the reduction in the cross-sectional area of the flow path of the blow pipe 30 creates a pressure loss, leading to a reduction in the pressure of the flow of hot air from the main hot air pipe 32 to the blast furnace main body 20. Thus, the pressure intake pipe 90a connected to the main hot air pipe 32 and the pressure intake pipe 90b connected to a downstream position of the blow pipe 30 are used to measure the pressure differential ΔP in the hot air 2 before and after the slag adhesion area using the differential pressure gauge 90, and the size of the pressure differential ΔP is used to estimate the slag S adhesion state.

The pressure differential ΔP so measured is compared to a preset threshold value, and used in opening and closing the open/close control valves 86 and 89 described above.

In the jet nozzle 80 described above, the slag removal may be carried out by ejecting the liquid 6 or the solids 7 separately, or the slag removal may be carried out by ejecting both of the liquid 6 and the solids 7 at the same time.

However, as a preferable slag removal method, the slag removal is initially carried out by only ejecting the liquid from the jet nozzle 80 as the removing slag in a first stage and, in a case where it is not possible to achieve a predetermined slag removal in the removing slag in a first stage, the solids 7 are ejected separately from the jet nozzle 80 as the removing slag in a second stage.

In addition, as necessary, removing slag in a third stage in which slag removal is carried out by ejecting the liquid 6 and the solids 7 from the jet nozzle 80 at the same time may be provided so as to be carried out in a case where it is not possible to achieve a predetermined slag removal in the removing slag in a second stage.

Specifically, in the slag removal in which the liquid 6 is ejected, there is an advantage in that there is little risk of wear, damage, or the like to the pipe in comparison with the slag removal by collision with the solids 7.

Accordingly, the removing slag in a second stage is carried out only when the removing slag in a first stage using the liquid ejection is carried out with priority and it was not possible to remove the slag S with the liquid ejection, for example, only when it was not possible to confirm that the slag removal was completed even when the liquid ejection was performed continuously for a predetermined time. As a result, it is possible to reliably remove even the slag S which was not removed with the liquid 6 using the force of the impact from the solids 7.

As a more preferable slag removal method, in a case where the solids 7 are ejected separately from the jet nozzle 80 as the removing slag in a second stage and it is not possible to achieve the predetermined slag removal even with the removing slag in a second stage in which only the solids 7 are ejected, the slag removal is further carried out by ejecting the liquid 6 and the solids 7 from the jet nozzle 80 at the same time as the removing slag in a third stage. It is desirable that a combustible liquid be used as the liquid 6 in the removing slag in a third stage.

It is possible to eject the liquid 6 and the solids 7 at the same time in the removing slag in a second stage.

Detailed description will be given below of the threshold value for the pressure differential ΔP and the process of controlling the opening and closing of the open/close control valves 86 and 89 based on the pressure differential ΔP measured by the differential pressure gauge 90. In the following description, both of the liquid 6 and the solids 7 are ejected at the same time and the operation of the delivery pump 85 is started so as to eject the liquid from the jet nozzle 80 in a state where the open/close control valve 86 is open.

In the embodiment, two threshold values are set; namely, a first threshold value (slag removal threshold value) HL for opening the open/close control valves 86 and 89 when the valves are in a closed state, and a second threshold value (slag removal stop threshold value) LL for closing the open/close control valves 86 and 89 when the valves are in an open state.

For the two threshold values, the same values may be used in the removing slag in the first stage, the second stage, and the like described above, or, for example, in a case such as where the removing slag in a first stage using liquid ejection is carried out with priority, values which are larger than the removing slag in a first stage may be used in the removing slag of subsequent stages.

In other words, the first threshold value (slag removal threshold value) HL is used to open the open/close control valves 86 and 89 and eject the liquid 6 and the solids 7 when the slag adhesion level detected by the differential pressure gauge 90 constituting the slag detecting means is determined to be at or above the slag removal threshold value.

The second threshold value (slag removal stop threshold value) LL is used to close the open/close control valves 86 and 89a and stop ejection of the liquid 6 and the solids 7 when the slag adhesion level detected by the differential pressure gauge 90 constituting the slag detecting means is determined to be less than the slag removal stop threshold value.

The open/close control valves 86 and 89 are set to the closed state when operation starts (i.e. at the initial setting), when there is no slag S adhesion, and the pressure differential ΔP detected by the differential pressure gauge 90 is lower than the second threshold value LL, with there being almost no pressure differential (ΔP≈0).

As the operation of the blast furnace continues from the initial setting described above, slag S gradually adheres to and accumulates on the side walls of the blow pipe 30 and the tuyere 20, with the result that the flow path resistance also gradually increases due to the reduction in the cross-sectional area of the flow path. Accordingly, when the value of the pressure differential ΔP detected by the differential pressure gauge 90 increases and reaches the first threshold value HL, this is detected by the differential pressure gauge 90, which outputs an open signal to the open/close control valves 86 and 89.

The open/close control valves 86 and 89 are opened as the result of the open signal, and, simultaneously, the delivery pump 85 is started. As a result, the liquid 6 stored in the liquid supply source 83 is ejected from the jet nozzle 80 toward the interior of the blow pipe 30, and, at the same time, the solids 7 which are stored in the solids supply source 87 are also ejected from the jet nozzle 80 toward the interior of the blow pipe 30.

As a result, when the ejected liquid 6 contacts the adhered slag S, the latent heat of vaporization thereof is lost, rapidly cooling the slag. For this reason, this rapid cooling causes the slag S, which is a vitreous, brittle solid to undergo rapid thermal shrinkage, breaking and removing the slag S, which undergoes thermal shrinkage as a result of the ejection of the liquid 6, from the side wall. Specifically, the slag S, having been broken into comparatively small chunks, is removed to the interior of the blast furnace main body 20 by the flow of hot air 2 and fluid.

On the other hand, the ejected solids 7 flow in the direction of the tuyere 22 with the flow of the hot air 2 and the brittle slag S which is a vitreous, brittle solid is broken and crushed by the force of the impact occurring when the solids 7 contact the adhered slag S. As a result, the slag S which receives the force of the impact upon colliding with the solids 7 is broken and removed from the wall surface. Specifically, the slag S, having been broken into comparatively small chunks, is removed to the interior of the blast furnace main body 20 by the flow of hot air 2 and fluid.

Removing the slag S in this way reduces the flow path resistance as the cross-sectional area of the flow channel increases, reducing the pressure differential ΔP detected by the differential pressure gauge 90. When the pressure differential ΔP detected by the differential pressure gauge 90 decreases so as to reach the second threshold value LL, the close signal is outputted to the open/close control valves 86 and 89. Since the open/close control valves 86 and 89 are closed according to the close signal and the operation of a delivery pump 92 is also stopped at the same time, the ejection of the liquid 6 and the solids 7 is stopped.

The first threshold value HL described above is set to a slightly larger value that the second threshold value LL used to open the open/close control valves 86 and 89 (i.e., HL>LL) in order to create hysteresis between the two values and prevent frequent opening and closing of the open/close control valves 86 and 89.

In this manner, the provision of the jet nozzle 80, which removes the slag S by using the latent heat of the vaporization of the liquid 6 to rapidly cool the slag S, or using the force of the impact of the solids 7 to pulverize the slag S, eliminates the need for blast equipment or the like for injecting hard balls or abrasive material. Moreover, the water, combustible liquid, or other liquid is converted to water vapor and combustible gas after being ejected, greatly facilitating the after-treatment following slag removal when the liquid ejection is carried out with priority.

In particular, if heavy oil or another combustible fluid is used as the fluid, the combustion of the combustible fluid further raises the temperature of the hot air.

In addition, in the embodiment described above, two threshold values, the first threshold value HL for opening the open/close control valves 86 and 89 when the valves are in a closed state and the second threshold value LL for closing the open/close control valves 86 and 89 when the vales are in an open state, are set, but a third threshold value HHL may also be set.

The third threshold value HHL is greater than the first threshold value HL for opening the open/close control valves 86 and 89 when the valves are in a closed state (i.e., HHL>HL); if a pressure differential ΔP in excess of this threshold value HHL is detected, it can be assumed that there is a problem in removing the slag S. Thus, if the pressure differential ΔP exceeds the third threshold value HHL, an alarm is outputted, for example, to a control room of the blast furnace so that the necessary measures can be taken forthwith, allowing major problems in the blast furnace, such as damage to the blow pipe 30, to be prevented before they occur. In other words, the third threshold value HHL is an alarm output threshold value set to a value at which the slag adhesion level is greater than the first threshold value (slag removal threshold value) HL described above.

In the interior of the blow pipe 30 described above, a swirling flow forming section which generates a swirling flow in the flow of the hot air 2 is provided at a position on the upstream side of the lance 31 from which the pulverized coal 3 is injected, that is, between a main hot air pipe 32 which supplies the hot air 2 and the lance 31. As this swirling flow forming section, for example, swirling vanes 33 as illustrated in FIG. 1 may be used, or a swirling ribbon 34 as illustrated in FIG. 2 as a modified example may be used. The swirling vanes 33 have a plurality of vanes having an angle with respect to the flow path cross-section arranged in the circumferential direction, and the swirling ribbon 34 is formed from thin plates into a spiral shape.

In this manner, when the swirling flow forming section such as the swirling vanes 33, the swirling ribbon 34, or the like is provided, the hot air 2 which flows inside the blow pipe 30 is made to have a swirling flow by passing through the swirling flow forming section. For this reason, the solids 7 which are injected from the jet nozzle 80 gather to the outer peripheral side due to the centrifugal force as a result of the influence of the swirling flow which is formed inside the blow pipe 30. Accordingly, effective slag removal is possible by causing the solids 7 to concentrate near and collide with the inner surface of the pipe of the blow pipe 30 or the inner surface of the tuyere 22 to which the slag S is adhered.

In this manner, according to the slag removal device and the slag removal method of the embodiment described above, since the slag S is destroyed and removed by the liquid ejection or the solids ejection, it is possible achieve easy and reliable slag removal using a simple device configuration even in a case of using the pulverized coal 3 that has not had the softening temperature thereof adjusted.

Furthermore, by carrying out the slag removal while prioritizing the liquid ejection, it is possible to reduce the risk of wear, damage, or the like occurring in the blow pipe 30.

Accordingly, adhering slag S can be broken and removed without having to adjust the softening point of the pulverized coal 3, allowing, for example, the maintenance interval of the blow pipe 30 to be extended to the wear lifespan of the tuyeres 22.

The component that is contained in the slag S produced by the pulverized coal 3 described above and is melted by the hot air 2 or the heat produced by the combustion of the pulverized coal 3, i.e., the low-melting point slag component, has an ash melting point of roughly 1,100 to 1,300° C. when hot air 2 of roughly 1,200° C. is used. A low-melting point slag component of this sort is also contained in modified coal produced by modifying low-grade coal, such as sub-bituminous coal or lignite, used as the feedstock coal for the pulverized coal 3 via drying, pyrolysis, or the like.

The present invention is not limited to the embodiment described above, and various modifications may be made thereto, as appropriate, within the scope of the invention.

### REFERENCE SIGNS LIST

1 Feedstock
2 Hot air
3 Pulverized coal (modified coal)
4 Carrier gas
5 Pig iron (molten iron)
6 Fluid
7 Solids
10 Metered feedstock feeder
20 Blast furnace main body
21 Furnace apex hopper
22 Tuyere
30 Blow pipe
31 Injection lance (lance)
32 Main hot air pipe
33 Swirling vanes (Swirling flow forming section)
34 Swirling ribbon (Swirling flow forming section)
40 Hot air feeder
50 Pulverized coal producing device
60 Cyclone separator
70 Storage tank
80 Jet Nozzle
81 Nozzle tip
86, 89 Open/close control valve
90 Differential pressure gauge
S Slag (ash)

1. A slag removal device for a blow pipe which is provided in a blow pipe that injects pulverized coal as an auxiliary fuel along with hot air through a tuyere into a blast furnace main body that produces pig iron from iron ore, with slag of the pulverized coal including a component that melts as a result of the hot air and/or combustion heat of the pulverized coal, the device comprising:
a jet nozzle that injects solids having a higher melting point than a temperature in the vicinity of the tuyere and having a particle diameter greater than that of the pulverized coal, into the pulverized coal that flows in the blow pipe and into the hot air, the jet nozzle being provided with a solids supply system that supplies the solids and has provided therein an open/close control valve.

2. The slag removal device according to claim 1, further comprising: a swirling flow forming section that generates a swirling flow in a flow of the hot air at a position on an upstream side of an injection lance that injects the pulverized coal in an interior of the blow pipe.

3. The slag removal device according to claim 1, further comprising: a jet nozzle that ejects a liquid toward a slag adhesion area in the blow pipe, the jet nozzle being provided with a liquid supply system that supplies the liquid and has provided therein an open/close control valve.

4. The slag removal device according to claim 1, further comprising: slag detecting means that detects a slag adhesion state according to a pressure differential between hot air pressure on an upstream side of the jet nozzle and hot air pressure in a vicinity of an outlet of the blow pipe.

5. The slag removal device according to claim 4, wherein the liquid and/or the solids are ejected by opening the open/close control valve upon the slag adhesion status detected by the slag detecting means being determined to be equal to or greater than a slag removal threshold value, and the ejecting of the liquid and/or the solids is stopped by closing the open/close control valve upon the slag adhesion level detected by the slag detecting means being determined to be less than a slag removal stop threshold value.

6. The slag removal device according to claim 5, further comprising: an alarm output threshold value set to a value at which the slag adhesion status is greater than the slag removal threshold value.

7. A slag removal method for a blow pipe which is applied in a blow pipe that injects pulverized coal as an auxiliary fuel along with hot air from a tuyere of a blast furnace main body that produces pig iron from iron ore, with slag of the pulverized coal including a component that melts as a result of the hot air and/or combustion heat of the pulverized coal,
and that is provided with a jet nozzle that injects solids having a higher melting point than the temperature in the vicinity of the tuyere and having a particle diameter greater than that of the pulverized coal, into the pulverized coal that flows inside the blow pipe and into the hot air, and a jet nozzle that ejects a liquid toward a slag adhesion area inside the blow pipe, the method comprising the steps of:
removing slag in a first stage in which slag removal is initially carried out by ejecting only the liquid from the jet nozzle; and
removing slag in a second stage in which slag removal is carried out by ejecting only the solids from the jet nozzle upon it not being possible to achieve a predetermined slag removal in the removing slag in a first stage.

8. The slag removal method according to claim 7, further comprising a step of: removing slag in a third stage in which slag removal is carried out by ejecting the solids and the liquid together upon it not being possible to achieve a predetermined slag removal in the removing slag in a second stage.

9. The slag removal device according to claim 2, further comprising: a jet nozzle that ejects a liquid toward a slag adhesion area in the blow pipe, the jet nozzle being provided with a liquid supply system that supplies the liquid and has provided therein an open/close control valve.

10. The slag removal device according to claim 2, further comprising: slag detecting means that detects a slag adhesion state according to a pressure differential between hot air pressure on an upstream side of the jet nozzle and hot air pressure in a vicinity of an outlet of the blow pipe.

11. The slag removal device according to claim 3, further comprising: slag detecting means that detects a slag adhesion state according to a pressure differential between hot air pressure on an upstream side of the jet nozzle and hot air pressure in a vicinity of an outlet of the blow pipe.
